(19) United States
(12) Patent Application Publication
(10) Pub. No.: US 2026/0307829 A1
(43) Pub. Date: Oct. 8, 2026

(54) ARTICULATED RING WING EVTOL STRUCTURE WITH DISTRIBUTED PROPULSION AND ADVANCED DYNAMIC PAYLOAD STABILIZATION SYSTEM AND INTEGRATED ENERGY REGENERATION AND SAFETY SYSTEMS

(71) Applicant: Aerial MECHANICA Inc., Pendleton, OR (US)

(72) Inventor: Arinze Ndubisi Eze, Edmonton (CA)

(73) Assignee: Aerial MECHANICA Inc., Pendleton, OR (US)

(21) Appl. No.: 19/308,830

(22) Filed: Aug. 25, 2025

Related U.S. Application Data
(60) Provisional application No. 63/688,029, filed on Aug. 28, 2024.

(51) Int. Cl. B64U 30/12; B64C 17/06; B64D 17/80; B64U 10/20; B64U 20/30; B64U 20/77; B64U 40/20; B64U 50/19; B64U 50/30; B64U 101/45; G05D 1/495; G05D 109/25; H02K 3/26

(52) U.S. Cl. CPC B64U 30/12; B64C 17/06; B64D 17/80; B64U 10/20; B64U 20/30; B64U 20/77; B64U 40/20; B64U 50/19; B64U 50/30; G05D 1/495; H02K 3/26; B64U 2101/45; F16B 2200/63; G05D 2109/254; H02K 2213/12

(57) ABSTRACT

An advanced electric vertical takeoff and landing (eVTOL) aerial vehicle, comprising an articulated annular wing structure integrated with distributed propulsion units, gyroscopic torque stabilization, and a guidance, navigation, and flight control system. The annular wing dynamically adjusts in flight to maintain payload stability, reduce stress on structural components, and mitigate passenger motion discomfort. A pseudo-centripetal force system, actuated by multi-axis mechanisms or an intelligent pulley assembly, is configured to counteract destabilizing forces during emergency landing scenarios. The aerial vehicle further includes a modular airframe architecture adaptable to multiple mission-specific configurations. Flight performance is optimized in real time using reinforcement learning algorithms. The system further comprises fail-safe mechanisms for rapid recovery from instability and includes integrated emergency and cybersecurity features to ensure operational safety. The disclosed VTOL vehicle provides enhanced stability, reliability, and versatility for applications including cargo transport, urban air mobility, environmental monitoring, emergency response, and agricultural operations.

### CROSS-REFERENCE TO RELATED APPLICATIONS

This application claims the benefit of U.S. Provisional Application No. 63/688,029, filed Aug. 28, 2024, which is incorporated by reference herein in its entirety for any purpose.

### BACKGROUND OF THE INVENTION

### 1. Field of the Invention

The present invention relates generally to the field of electric vertical takeoff and landing (eVTOL) aircraft and aerial vehicle design. Particularly, the invention relates to an electric vertical takeoff and landing aircraft featuring a modular, articulated ring-wing airframe structure integrated with distributed propulsion coreless stator electric motor propulsion units, fabricated using advanced additive manufacturing techniques for bimetallic components offering unprecedented thrust-to-weight ratios by eliminating iron-core losses and leveraging aerodynamic principles to multiply thrust. More particularly, the invention pertains to systems and structures that improve aerodynamic efficiency, structural adaptability, energy regeneration, dynamic payload stabilization, and in-flight safety for aerial vehicles operating in complex or turbulent environments.

### 2. Description of Related Art

Both fixed-wing and multirotor configurations in current drone technologies have advanced significantly but still face critical limitations that hinder their effectiveness in various applications. Fixed-wing drones, while efficient for long-range travel, lack the necessary maneuverability for operations in confined, unstructured or dynamic environments. Conversely, multirotor drones like quadcopters and hexacopters offer greater agility and the ability to hover, yet they suffer from inherent stability issues, particularly when tasked with carrying heavy or liquid payloads.

One significant drawback of conventional multirotor designs is the reliance on large propeller blades for lift. Although increasing blade diameter can improve lift, it also exacerbates the issue of increased moment of inertia, which in turn compromises the eVTOL's nimble ability to quickly adjust its attitude during flight. This fundamental trade-off between lift efficiency and maneuverability presents a persistent engineering challenge, particularly in scenarios demanding both stability and rapid response, exacerbated by nonlinear dynamics and sensor dropouts in legacy control systems.

The problem of transporting liquid payloads adds another layer of complexity. Traditional drones configured with partitioned tanks or ferry containers with baffles attempt to mitigate sloshing but at the cost of added weight and design complexity. Moreover, these solutions are not always effective, especially in dynamic flight conditions where the movement of the liquid can still lead to destabilization of the entire aircraft flight control. This is equally problematic in eVTOLs designed for passenger transport, where the resulting motion inconsistencies from turbulence and sudden wind gusts can cause significant discomfort, including motion sickness to the passenger on board.

In response to these issues, various technologies have been introduced in the industry in various forms, such as viscous dampeners to oleo-pneumatic struts at the landing gear along with a few computer-based Inertia Reference Systems. However, these technologies are often narrowly focused on counteracting by adjusting the gimbal's position, addressing only specific aspects of an aerial vehicle's undesired movements rather than providing a comprehensive solution to the broader challenges of stability and maneuverability. Instability and turbulence management in related art is passive, risking foreign object debris (FOD), collision or interference, and lacks onboard intelligence to handle unpredictable flight circumstances in real time.

Efforts to enhance drone and UAV propulsion systems have led to the development of variable-pitch propellers and distributed propulsion models, which improve responsiveness. Yet, these systems still struggle with balancing the competing demands of lift efficiency, agility, and overall stability, particularly in adverse flight conditions. Moreover, traditional safety measures like collision avoidance systems, while beneficial, tend to limit operational versatility by imposing strict flight parameters. Conventional iron-core motors suffer from eddy losses and heat buildup, restricting power density. Battery systems lack rapid isolation for thermal runaway, per RTCADO-311A. Certification processes are manual, delaying compliance with EASA SC-VTOL Issue 2 (2025). Additive manufacturing for stators takes up over 35% of the manufacturing process. Whereas aerial vehicles require enormous amounts of energy to stay continuously operational, current clean energy systems still require enormous infrastructure and technically share limited commonality with eVTOL technologies of today.

As Unmanned Aerial Vehicle (UAV) technology has advanced, a persistent challenge has been balancing lift efficiency with maneuverability. Traditional drone designs frequently encounter a trade-off between maximizing lift—typically achieved through larger propeller blades—and maintaining the ability for rapid attitude adjustments, which require a reduced moment of inertia. This fundamental trade-off limits the responsiveness of drones in dynamic environments, particularly during complex maneuvers or in turbulent conditions, as seen in ASTM F3264-24 normal-category aeroplanes.

Furthermore, when drones are tasked with carrying liquid or viscous payloads, they encounter additional stability challenges. The movement of liquid within containers can lead to sloshing and splashing, which destabilizes the vehicle, compromising the safety of both the drone and its payload. Existing solutions, such as internal baffles and partitions, add weight and complexity without fully resolving these issues.

To mitigate these challenges, many manufacturers have implemented restrictive safety features, including collision avoidance systems and stringent operational limitations. While these measures enhance safety, they also constrain the versatility and operational utility of drones, especially in applications requiring precise control and high stability, such as industrial inspection, agricultural operations, or emergency medical services. Moreover, statistical data indicates that a significant percentage of drone accidents occur at low altitudes, where UAVs are most susceptible to external forces like wind gusts, ground effects and vector-ring states leading to non-recoverable situations.

The present invention overcomes limitations in related art by introducing a novel electric vertical takeoff and landing (eVTOL) aircraft design that integrates an articulated ring-wing structure with a distributed propulsion system and dynamic stabilization mechanisms. This innovative configuration enhances stability and safety while expanding the operational capabilities of drones, making them more adaptable and versatile in challenging environments and for applications involving sensitive or unstable payloads. The invention described by the disclosure herein advances beyond prior limitations through the use of an annular airframe component that is smart with modularized subsystems and can articulate its geometrical structure. The novel hybrid passive-active gust and turbulence alleviation torque network that uses real-time gyroscopic sensor data to adjust control surfaces—providing different levels of isolation for varying disturbance frequencies—integrated into the pseudo-centripetal cabin mechanism and the implementation of Reinforcement Learning (RL) algorithms for adaptive control represent a significant departure from existing technologies. Enhanced by energy regeneration, optimized propulsion units, battery modularity for safety, and AI-driven certification tools, this invention offers benefits over traditional aircraft by being easier to design, simpler to construct, quieter to fly, and more economical to operate. It addresses safety gaps and challenges in airman certification that currently hinder the scaling of powered-lift operations as noted in FAA powered-lift SFAR (2024).

### BRIEF SUMMARY OF THE INVENTION

The advanced articulated ring-wing described herein is distinguished by its modularized structure, which serves as the primary airframe of the eVTOL configuration. This unique annulus airframe supports distributed propulsion units, each capable of variable thrust output. The propulsion units are strategically positioned on the ring-wing optimally to provide a distributed thrust for the drone or e VTOL unit with articulation and airframe morphing capabilities. The core innovation lies in the development of a pseudo-centripetal CG-shifting mechanism, implemented via a network of multi-axis actuation of pulleys and cable system. This mechanism actively counters destabilizing forces during flight, ensuring that the payload remains stable and properly aligned with gravitational forces, even during sharp maneuvers or under turbulent conditions all controlled via the Dynamic Gyroscopic Torque Network (DGTN) for rapid torque injection and actuation.

The ring-wing articulates dynamically in response to the eVTOL's flight parameters, allowing the e VTOL to bank smoothly during turns while maintaining the payload's center of mass perpendicular to the cabin floor or tank bottom. This design minimizes reliance on friction for directional changes, effectively reducing sloshing in liquid payloads, thereby mitigating the risk of motion sickness for passengers and enhancing the stability of transported liquids. At critical, emergency or dangerous descent, barn-door flaps morph into ram-air non-elliptical canopies designed to slow descent by trapping pockets of air inducing drag resistance leading to a reduction in the vehicle's downward terminal velocity for a much more comfortable and soft landing.

The eVTOL's modular design supports various configurations, such as Twincopter and Quadcopter, tailored to specific needs. Reinforcement Learning (RL) algorithms optimize the vehicle sizing, configuration and flight performance in real-time. This innovative design significantly enhances stability, safety, and versatility, making the aerial mobility vehicle ideally suited for applications like cargo transport, urban air mobility services, environmental monitoring, emergency services, and agricultural operations, supported by the Lift 8™ Vertipad for energy regeneration and the Aviabox™ CGCC for certification compliance.

The eVTOL's control system is enhanced by a stack of Reinforcement Learning (RL) agents and deterministic algorithms that dynamically adjust the variable speed propellers based on real-time sensor data from the Deafferented Locus Intuition (DaLI) logic core for control allocation.

Incorporated fail-safe mechanisms ensure rapid recovery in the event of flight instability or system failure. These mechanisms include actuators and servos embedded within the ring structure, which can instantly trigger a power increase from the distributed propulsion units, enabling the drone to stabilize swiftly and continue its mission with minimal disruption. Other fail-safe systems include the Battery Anti-Runaway Quick Disconnect (BAR-QDIS) deterministic differential remapping monitor for thermal event containment.

The eVTOL is equipped with a hybrid phase-stabilized sensing system ‘Mission Critical’ procedures that controls the vehicle using the continuous feedback from its deterministic remapping monitoring system to DaLI control allocation during service operation. The ‘Mission Critical’ function is tested using both the Inner “Stabilization” Loop that constantly self-references within time horizons to correct for its own internal phase drifts (caused by the temperature and vibrations) like passive Electromagnetic Compatibility (EMC) testing for interference between critical systems and the Outer “Sensing” Loop & Remapping for reflected pattern decoded by the deterministic NN on the aircraft's structural and thermal state as active.

The drone/eVTOL has onboard cybersecurity measures integrated into its design, ensuring that all data transmissions and control systems are protected from potential breaches or adversarial attacks. The Cybersecurity Risk Management (CSRM) requirements are thoroughly assessed to ensure compliance with devices such as communication transmitters and receivers, control devices, and cloud servers. All applications utilized to manage or control drones undergo detailed risk assessments to ensure that they function correctly, that data is transmitted securely, and that firmware updates do not introduce vulnerabilities, with the Aviabox™M CGCC providing continuous regulatory and maintenance monitoring.

Overall, this invention represents a significant leap forward in drone technology, offering unparalleled stability, safety, and operational versatility. The design is particularly advantageous for applications demanding high stability, such as the transportation of liquid payloads or passengers, as well as operations at low and very low altitudes or unstructured and collision-prone environments. Additionally, the modular and adaptive nature of this aerial vehicle positions it as a transformative solution for a wide array of industries, setting new benchmarks in UAV performance and reliability, extended by self-monitoring to energy regeneration and AI-driven controllability tools.

### BRIEF DESCRIPTION OF SEVERAL VIEWS OF THE DRAWINGS

A more complete understanding of embodiments of the present invention may be obtained by reference to the following Detailed Description when taken in conjunction with the accompanying Drawings wherein:

FIG. 1 illustrates views of the articulated ring-wing intelligent airframe, illustrating the overall structure including planar “barn-door” state and its concave “para-brella” state, according to one embodiment of the present invention;

FIG. 2 illustrates views of the modular variation of a quad-copter, tri-copter, hexacopter, and octo-copter configurations of the eVTOL, according to one embodiment of the present invention;

FIG. 3 illustrates a view of a modular 19-rotor ring-wing, illustrating a coreless stator motor, according to one embodiment of the present invention;

FIG. 4 presents a diagram of the dynamic gyroscopic torque network, according to one embodiment of the present invention;

FIG. 5 is a view of a BAR-QDIS Decentralized Battery Module (DBM), showing a cell array, a thermo-structural shell, and Ultra-Fast Isolation Stack (UFIS) couplers, according to one embodiment of the present invention;

FIG. 6 illustrates a perspective view of a vertipad with an octagonal deck and eight surrounding bi-directional ring-wing booster/harvester modules, according to one embodiment of the present invention;

FIG. 7 illustrates an eVTOL equipped with an agriculture crop dusting robotic extension-boom spray, demonstrating its articulation and proximity to a target canopy, according to one embodiment of the present invention;

FIG. 8 illustrates an airborne wind energy system, depicting a semi-rigid kite with embedded sensor web, a tether, and a ground station ERgU, according to one embodiment of the present invention; and,

FIG. 9 collectively illustrates an integrated software platform for the eVTOL for overall management of all aspects of the drone's flight performance, according to one embodiment of the present invention.

### DETAILED DESCRIPTION OF THE INVENTION

In the following description, numerous specific details are set forth to provide a thorough understanding of the present invention. However, it will be apparent to those skilled in the art that the present disclosure may be practiced without such specific details. It is to be understood that both the foregoing general summary description and the following detailed description are illustrative and explanatory, and are not restrictive of the subject matter, as claimed. It is to be further understood that the following disclosure also provides many different embodiments, or examples, for implementing different features of various illustrative embodiments. Specific examples of components and arrangements are described below to simplify the disclosure. These are, of course, merely examples and are not intended to be limiting. For example, a figure may illustrate an exemplary embodiment with multiple features or combinations of features that are not required in one or more other embodiments and thus a figure may disclose one or more embodiments that have fewer features or a different combination of features than the illustrated embodiment. Embodiments may include some but not all the features illustrated in a figure and some embodiments may combine features illustrated in one figure with features illustrated in another figure. Therefore, combinations of features disclosed in the following detailed description may not be necessary to practice the teachings in the broadest sense and are instead merely to describe particularly representative examples. In addition, the disclosure may repeat reference numerals and/or letters in the various examples. This repetition is for the purpose of simplicity and clarity and does not itself dictate a relationship between the various embodiments and/or configurations discussed.

In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise. In addition, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “inboard,” “outboard,” “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. The terms “drone”, “eVTOL”, “advanced air mobility”, “aircraft”, “unmanned aerial mobility”, “UAV” and “aerial robotics” are used interchangeably to refer to the vehicle throughout this documentation.

As may be used herein, the terms “connect,” “connection,” “connected,” “in connection with,” and “connecting” may be used to mean in direct connection with or in connection with via one or more elements. Similarly, if the terms “couple,” “coupling,” and “coupled” are used they mean directly coupled or coupled via one or more elements. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include such elements or features.

The term “substantially,” “approximately,” and “about” is defined as largely but not necessarily wholly what is specified (and includes what is specified; e.g., substantially 90 degrees includes 90 degrees and substantially parallel includes parallel), as understood by a person of ordinary skill in the art. The extent to which the description may vary will depend on how great a change can be instituted and still have a person of ordinary skill in the art recognize the modified feature as still having the required characteristics and capabilities of the unmodified feature. In general, but subject to the preceding, a numerical value herein that is modified by a word of approximation such as “substantially,” “approximately,” and “about” may vary from the stated value, for example, by 0.1, 0.5, 1, 2, 3, 4, 5, 10, or 15 percent.

The section headings used herein are for organizational purposes and are not to be construed as limiting the subject matter described. If any documents, or portions of documents, are cited in this application, including, but not limited to, patents, patent applications, articles, books, and treatises, such documents are hereby expressly incorporated herein by reference in their entirety for any purpose. In the event that one or more of such incorporated documents etc. and similar materials (if any) defines a term in a manner that contradicts the definition of that term in this application, this application controls. References to prior art are included for context and to highlight how the invention advances the field. During the discussion of the structural features of this invention, all references to controllers, displays, sensors, etc. and the like should be considered in their broadest aspect.

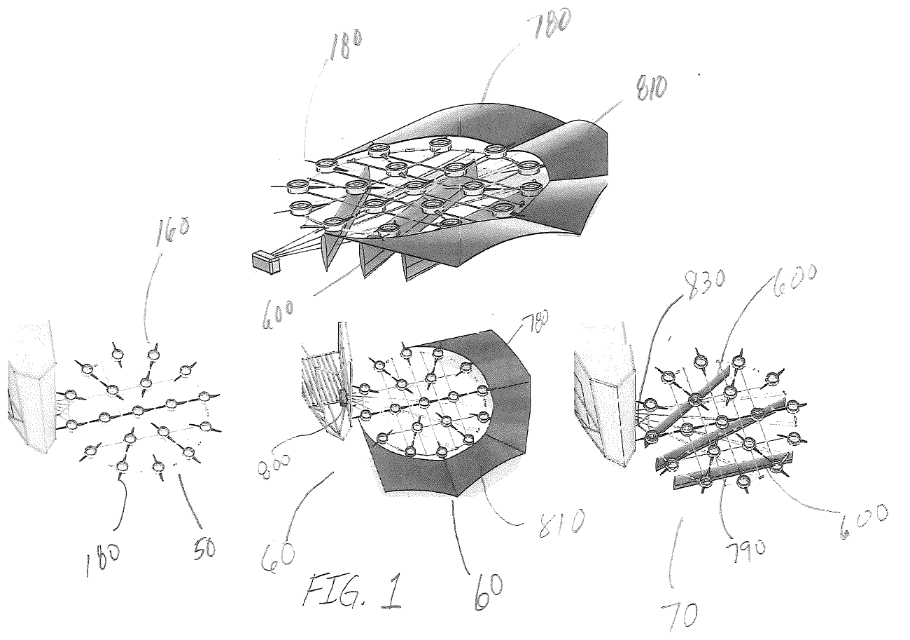

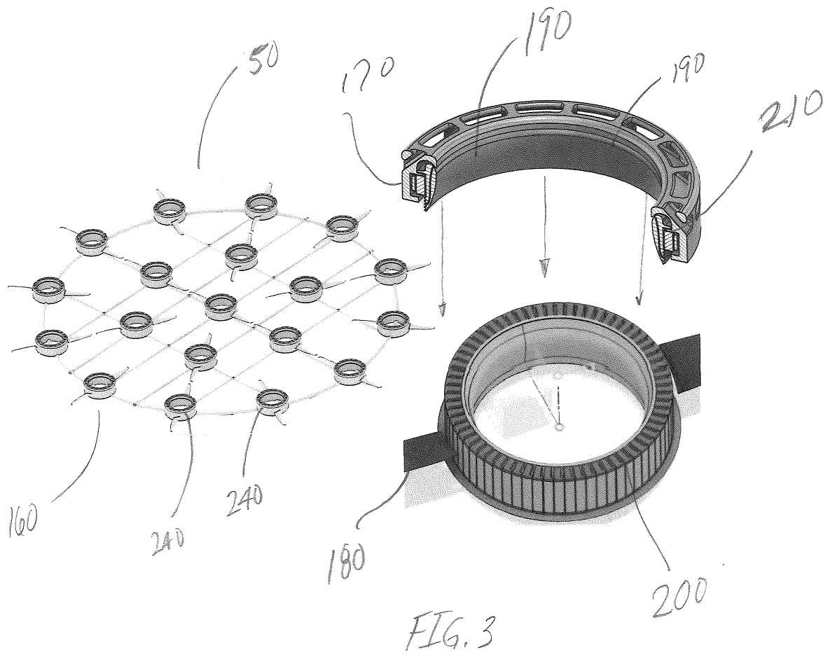

The invention is centered around a ring-wing structure 50 that serves as a primary airframe for the invention, as shown in FIG. 1 and FIG. 3. This ring-wing structure 50 is a load-bearing structure that houses distributed propulsion units 160, each capable of generating variable thrust. As shown in FIGS. 1-5, the propulsion units 160, consist of direct-drive brushless out-runner motors 170, coupled with free-running swivel propellers 180 and a coreless center for thrust multiplication 190. This configuration strikes a balance between lift efficiency and rapid attitude adjustments, addressing the conflicting requirements of maximizing blade surface area for lift and minimizing the moment of inertia for responsiveness.

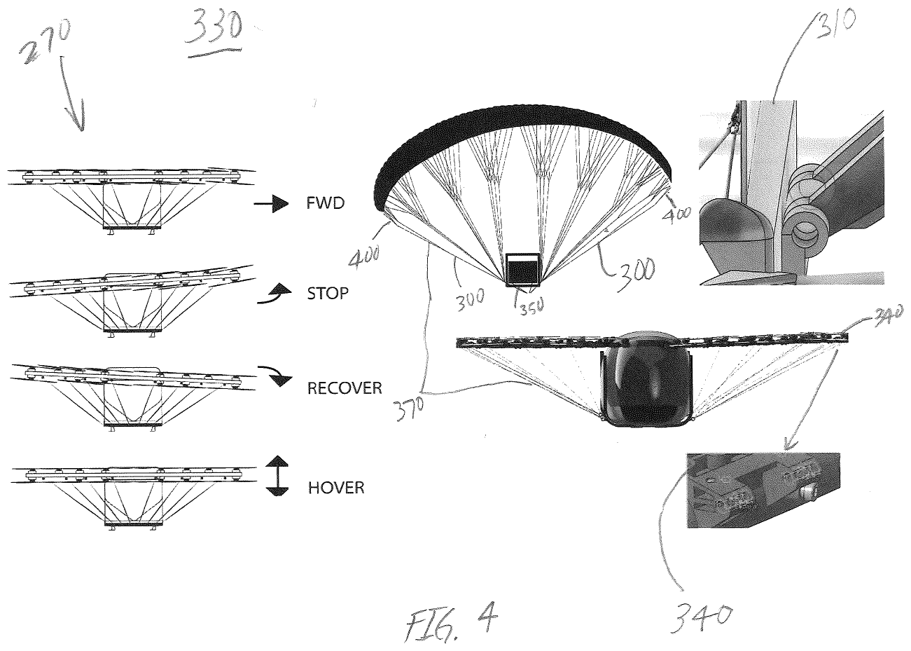

The ring-wing structure 50 is connected to an eVTOL fuselage undercarriage through a pivoting suspension system 270, as shown in FIG. 4, that allows the ring-wing structure 50 to articulate in real-time. This articulation is responsive to the flight dynamics of the ring-wing structure 50, maintaining the payload's center of mass in alignment with gravitational force and other induced forces to the fuselage or cabin section. The pivoting suspension system 270 plays a critical role in stabilizing the payload during flight, particularly when executing sharp maneuvers or navigating turbulent conditions. This stability is further enhanced by the generation of a pseudo-centripetal gyroscopic torque through a network of multi-axis actuators from an array of intelligent pulley and cable system 300 as shown in FIG. 4. This force management system counteracts destabilizing forces, ensuring that the payload remains stable and properly oriented throughout the flight.

For liquid or viscous payloads, a Dynamic stabilization system 310 is designed to mitigate sloshing and splashing by maintaining the payload's orientation relative to the gravitational vector. This is particularly important for applications where the stability of the payload is critical, such as in the transportation of hazardous materials or sensitive liquids. In passenger transport applications, this same principle reduces motion sickness by aligning the passenger's visual and vestibular inputs, thereby minimizing sensory conflicts and providing a more comfortable flight experience.

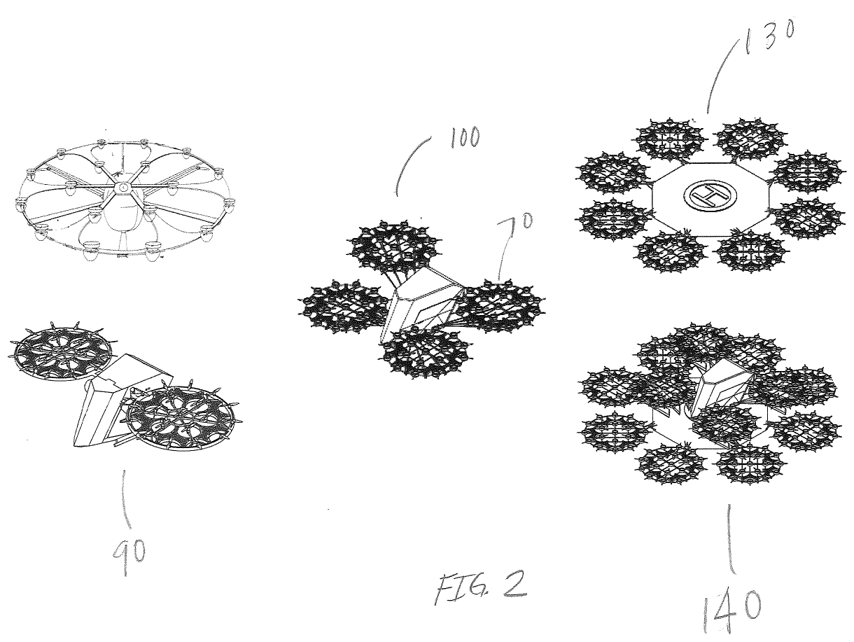

The primary airframe 60 modular design allows for various configurations, which can be adapted to suit specific operational requirements, as illustrated in FIG. 2. For instance, the twincopter 90 configuration, with two ring-wings 70, offers a simpler design suitable for balanced payloads, while the quadcopter configuration 100, with four ring-wings 70, provides enhanced lift efficiency for heavier payloads. The tricopter configuration, featuring three ring-wings 70, balances lift and maneuverability, making it ideal for dynamic environments where rapid attitude adjustments are necessary. The hexacopter 120, octacopter 130, and an decacopter 140 configurations, offer additional stability, redundancy, and morphological variations, making them suitable for higher lift capabilities and riskier operations in challenging environments, with each ring wing fixed with nineteen rotors for consistent performance.

The propulsion unit 160 of the present invention, as depicted in FIG. 3, is a significant advancement, comprising Induction-Coandă-Entrainment (I-C-E) coreless stator motors 200. Unlike conventional BLDC motors, the stator 210 is fabricated without a ferrous core, drastically reducing weight and eliminating eddy current and hysteresis losses. The stators 210 are constructed using a bimetallic additive manufacturing process, where high-purity copper windings are directly printed onto a low-carbon-steel or Fe—Ni structural base, separated by a nano-film diffusion barrier. This method achieves a slot-fill factor exceeding 90%, embedding cooling micro-channels and bus-bar terminations into a single monolithic component.

The I-C-E principle multiplies effective thrust. An upstream stage pre-accelerates airflow into the propulsors. The motor housing 240 and ring-wing 70 surfaces are shaped to exploit the Coanda effect, ensuring attached, laminar flow. Finally, strategically designed Entrainment ducts use the high-velocity exhaust to draw in additional ambient air, increasing the total mass flow and, consequently, the thrust, without additional power consumption. This architecture allows the eVTOL to operate on a high-voltage (800-1000V) DC bus, further minimizing I²R losses and enhancing overall system efficiency.

One of the key innovations of the present invention is conceptualization of the inverted Spill-Not, which is adapted from the Spill-Not, a common laboratory apparatus designed to prevent spills in static conditions. The inverted Spill-Not concept, actively manages forces in dynamic flight scenarios, reducing sloshing in liquid payloads and minimizing motion sickness in passengers. This is achieved by maintaining a constant orientation of the payload relative to gravity, even during sharp turns or rapid braking. Unlike the current gimbal-stabilization systems today, the dynamic stabilization system, combined with the articulating ring-wing 70, continuously counteracts forces while able to compensate for the broader change in direction inputs from the vehicle's controller.

The stability system is upgraded to a dynamic gyroscopic torque network (DGTN) 330, illustrated in FIG. 4. This stability system actively rejects disturbances using three synergistic layers. The first is a structural-gyro layer 340, comprising miniature, high-speed gyro-torque injectors (GTIs) 350 co-axially coupled to each rotor hub and servo-actuated tension-brace nodes (TBNs) 370. The GTIs 350 inject precise precessional torques to counteract roll, pitch, and yaw moments in milliseconds, while the TBNs 370 modulate the airframe's 60 center of gravity. This physical layer is managed by a high-speed edge-compute network and a central control logic running the proprietary deafferented locus intuition (DaLI) algorithm 390. DaLI solves a real-time constrained convex optimization problem, allocating control effort between gyros 350, rotors 160 (shown in FIG. 3), and braces 400 to achieve minimum-energy disturbance rejection, providing multi-path redundancy and fault tolerance far superior to the original passive system.

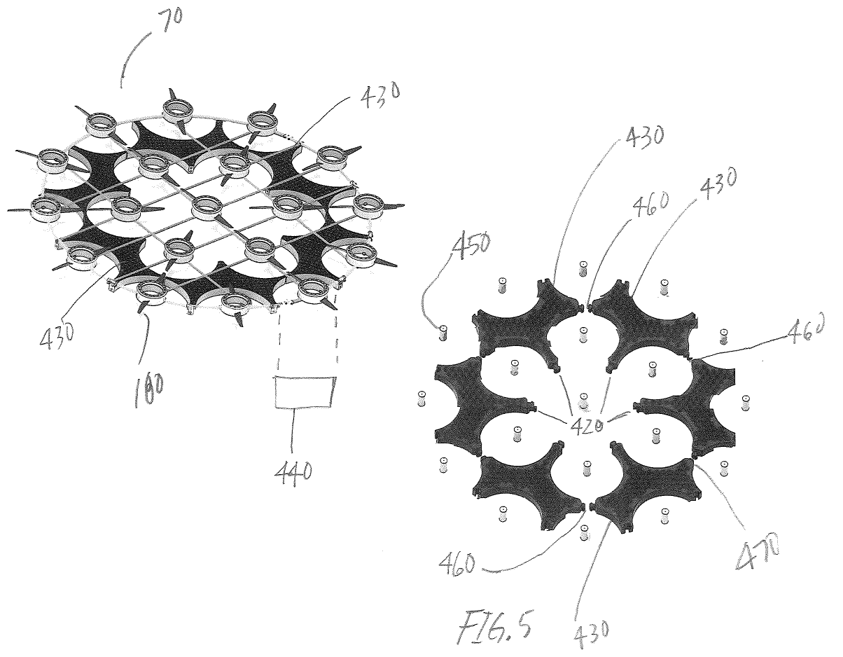

As shown in FIG. 5, to address the critical safety aspect of high-energy batteries, invention incorporates a battery anti-runaway quick disconnect and isolation system (BAR-QDIS) 420. The system eschews a single monolithic battery in favor of multiple decentralized battery modules (DBMs) 430. Each DBM 430 is a self-contained unit with its own thermo-structural shell, embedded battery management micro-regulator (BMM) 440, and a multi-layer sensor suite 450 (temperature, pressure, voltage, acoustic). Data from the multi-layer sensor suite 450 feeds a physics-informed neural network that predicts incipient thermal runaway with several seconds of advance warning.

Further in FIG. 5, upon detection of a critical hazard score, the BMM 440 triggers an ultra-fast isolation stack (UFIS) 460. In under 5 microseconds a frangible dowel pin (not shown) is thermally disintegrated, and the gallium-nitride opens, followed by a redundant pyrotechnic fuse (not shown) severing a main busbar. The faulty DBM 430 is thus galvanically isolated, preventing thermal propagation. The remaining DBMs 430, coordinated via a redundant power reconfiguration bus 470, instantly re-balance the load, allowing the aircraft to maintain controlled flight and land safely.

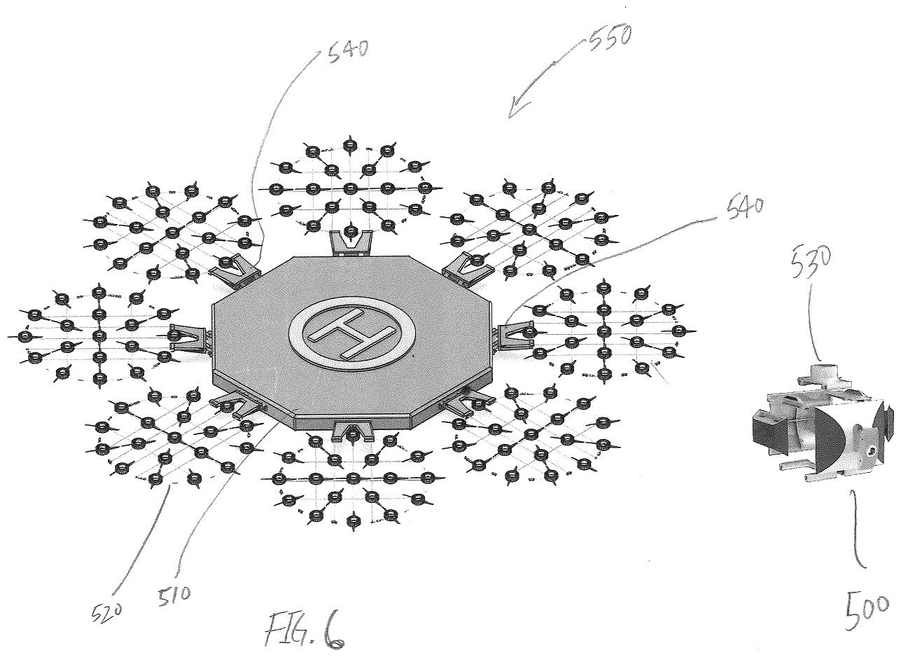

In reference to FIG. 6, the eVTOL 60 operates as part of a wider ecosystem that includes a vertiport 490. This is not a passive landing pad but an active energy regeneration ground unit (ERgU) 500. The central octagonal deck 510 is surrounded by eight articulated ring-wing modules 520 embedded flush with the surface. During an eVTOL's arrival, these modules 520 act as low-pressure turbines 530, capturing the kinetic energy of the rotor downwash. This energy is routed through a generator embodying a bimetallic 3-D-printed coreless stator design 540 (sharing technology with the eVTOL's motors).

The energy captured from the downwash and stored in the vertiport docking station 550 recharges the vertiport 490 once it lands back on dock via its on-pad super-capacitor power bank while readying for the next takeoff. This process of “thrust-assist kick” trims 8-12% from the eVTOL's 60 battery draw during the most energy-intensive phase of flight, effectively extending its operational range. The ERgU 500 captured downwash jet of airflow through the inlet vent driving the impeller, injects a uniform up to 14 kN of recycled energy to the ERgU drum component of the docking station generator unit 560.

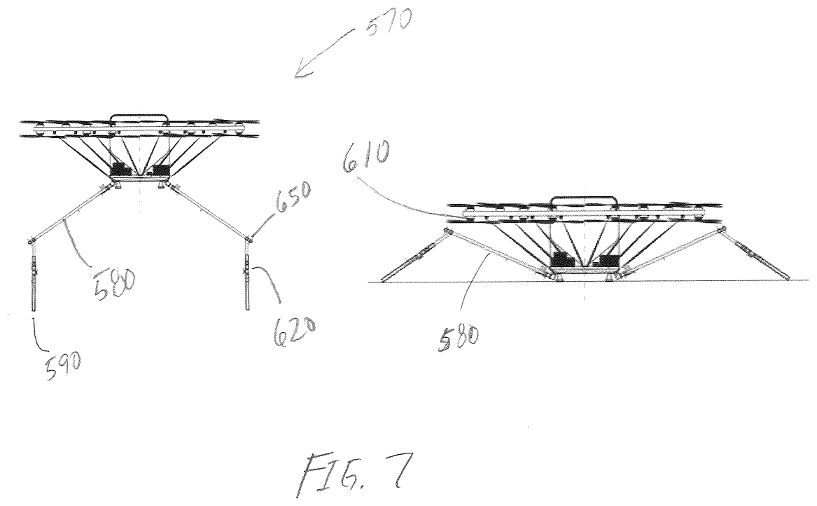

The eVTOL 60 is designed as a versatile tool carrier. One such embodiment is a robotic spray arm 570 for precision spray-as-a-service (pSpAAS), depicted in FIG. 7. This multi-segment, boom extension 580 can break through crop canopy and maneuver the PACE-PSN nozzle 590 for close-contact application during the spraying operation, eliminating drift or low-efficacy application. Coordinated by a DaLI algorithm, the spray arm's 570 movements are compensated for in real-time by the DGTN 330 (see FIG. 4) and the para-brella ‘barn-door’ 600 (see FIG. 1) configuration to deflect downwash so that the crops underneath are prevented from flailing violently or lodging from the downwash force. The airframe also remains perfectly stable even while the boom extension 580 is in motion, and the spray droplets do not drift, disintegrate, or evaporate before hitting the targeted plant pores.

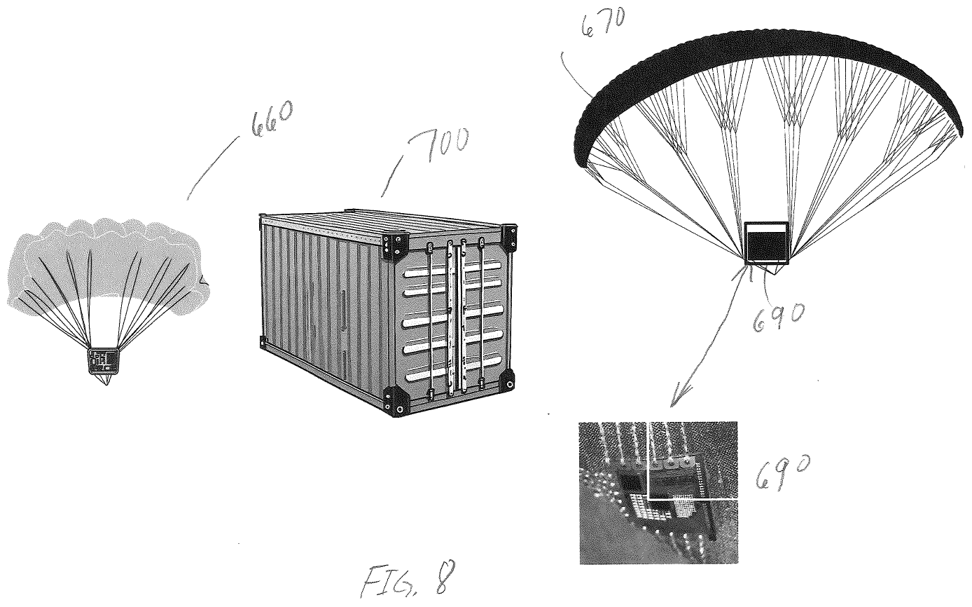

Furthermore, the ecosystem includes an airborne wind energy system 660 (see FIG. 8). A semi-rigid kite 670, incorporates shape-memory materials and an embedded sensor web 690, generates power via a pumping cycle managed by software architecture and a ground station ERgU 700 that shares components with the eVTOL 60 and the vertiport 490. This synergy creates a closed-loop system where the semi-rigid kite 670 can generate power to charge an eVTOL fleet, enabling truly off-grid, sustainable operations.

The control system software is enhanced by reinforcement learning (RL) algorithms which dynamically adjust the variable speed propellers 180 (shown in FIG. 3) based on real-time sensor data. These algorithms continuously learn from the aerial vehicle's 60 operational environment, optimizing the propeller speeds and wing articulation to improve stability, control, and efficiency. The integration of RL algorithms reduces the computational demands on an inertial measurement unit (IMU), potentially leading to more efficient and cost-effective control systems. The RL algorithm stacks are integrated with deafferented locus intuition algorithm, dynamic gyroscopic torque network 330, and the sensor suite 450 (see FIG. 5) for predictive flight recovery.

Within the code architecture, specific algorithms are designed to train the neural network-based control system capable of managing and optimizing flight of the eVTOL 60 continuously during operations. This system collects real-time data on the eVTOL's 60 state—such as altitude, proximity, and velocity—through sensors 450, and the RL agent selects the optimal actions, such as adjusting throttle, propeller thrust, or wing articulation, based on this data. The control system integrates a hybrid of deterministic differential remapping with Physics-Informed Neural Networks (PINNs) that incorporate physical laws directly into the control's architecture, ensuring that the control commands are physically realistic. The eVTOL 60 is capable of autonomous operation, executing missions with minimal human intervention. It uses a combination of onboard sensors 450, RL algorithms, and real-time data processing to navigate, avoid obstacles, and complete tasks. Safety protocols such as the BAR-QDIS 420 (see FIG. 5) for battery faults are embedded in the control system, allowing the drone to react swiftly to unexpected changes internally or in the environment, such as sudden obstacles or changes in weather conditions.

The control system's design is a combination of non-linearized frameworks of auto-differentiation of flight models and parameter tuning for variable external disturbance and internal health monitoring, integrating dual quaternion-based kinematics with adaptive Model Parameters, noise and Compensation Estimations, and Predictive Paths in a hybrid control system for better data-centric neural network. This autonomous operation allows the aerial vehicle 60 to perform complex missions with minimal human intervention, dynamically adapting to environmental changes, and executing real-time decision-making processes.

The vehicle 60 is equipped with several fail-safe mechanisms 830 (see FIG. 1) designed to ensure operational safety in the event of flight instability or system failure. These features are particularly important for low-altitude operations, where traditional eVTOLs 60 are most vulnerable to excoriating flight dynamics, external forces, and sudden load changes. The eVTOL 60 can perform sustained low and very low altitude flight activities in a controlled and stable performance. In FIG. 1, when deployed, the non-ballistic para-brella 780 regulates sudden or planned vertical descent by managing airflow, or mitigating ground debris projectiles from the downwash. Releasing a set of shape-memory fabrics 790 forming a set of paraglide systems 800 (para-brella) deployed from the rim of the propulsion ring. The non-ballistic para-brella 780 fabric structure unfolds during descent, reducing air turbulence and enhancing flight stability.

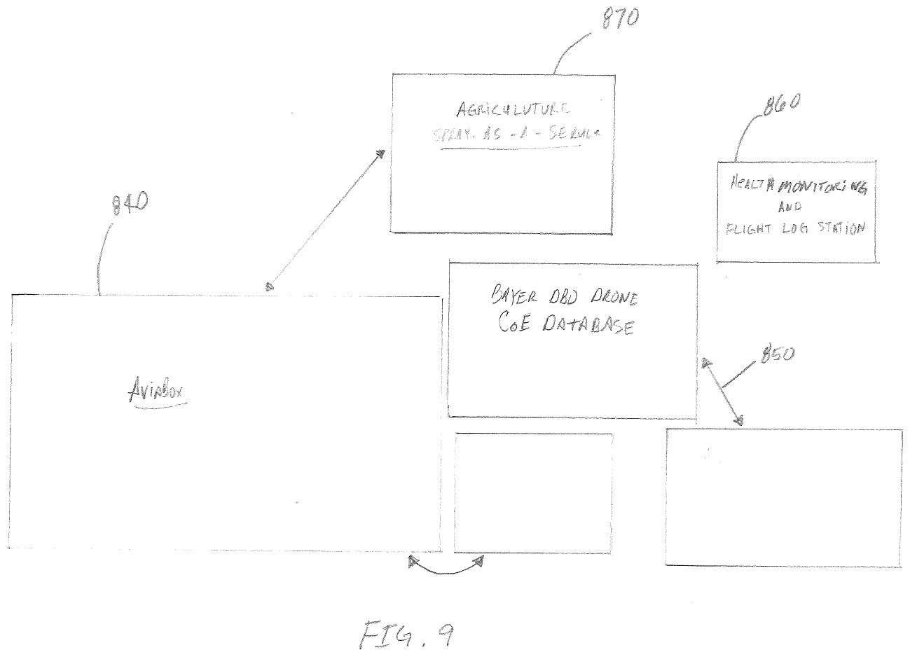

In general reference now to FIG. 9, the combination of safety features in this eVTOL 60 ensures 100% guaranteed safe operations at all times. The eVTOL's 60 Aviabox 840 conformity and general compliance certification (CGCC) stack 850 is the health monitoring and flight log station 860 where all flight logs are downlinked post-flight, determining maintenance schedules and unscheduled regulatory compliance evaluations for optimal operational services. For a vehicle configuration for agriculture spray-as-a-service 870, Aviabox 840, the CGCC stack 850 and other the systems combine to provide specific operational requirements like weight, spray-nozzle standard, targeted contact surface, payload characteristics, flight hover, altitude, approach, and landing site using real-time data from the 60 onboard multi-layer sensor suite 450, adjusting the propulsion, dynamic gyroscopic torque, and stabilization systems to ensure safe flight operations and post-flight maintenance.

The articulated eVTOL 60 is designed modular and intelligent to operate in a variety of complex environmental conditions, including windy and turbulent, humid to extreme temperatures, low-altitude operations, unstructured zones, and areas with high collision risks. The eVTOL's 60 design also allows it to handle extreme weather conditions, such as rain and dust storms, although there are limitations in severe storms or high-altitude performance outside the vehicle's flight envelope. The eVTOL 60 can be equipped with sensors 450 that predict and respond to adverse weather conditions, such as incoming storms or high winds, adjusting its flight path or altitude until it can successfully abort the mission-supported by systems such as CGCC 850 for compliance verification.

The eVTOL's 60 technical specifications include a hybrid propulsion system, primarily electric with the option for fuel cells, offering a balance between endurance and operational range. The variation in weight depends on the type of configuration and the payload capacity. Typically, the annulus stacking as quad-, tri-, hexa-, or octa-configuration impacts the weight ranging from 50 to 700 kg, the flight distance with energy regeneration from the energy regeneration ground unit (ERgU) 500, as well as payload capacity of 20 to 300 kg. This makes the eVTOL 60 suitable for a range of applications, including cargo transport, environmental monitoring, agricultural spraying, and passenger transport.

The agriculture robotic spray arm 570 has a thrust-augmented compact-torque (TACT) actuator 610, which integrates a high-torque, direct-drive axial flux motor and an embedded air multiplier at its coreless center, as illustrated in FIG. 7. This subcomponent offloads the primary motor during peak torque events as the boom extensions 580 extend to release substances from the payload, controlled by the cutoff valve 620 in the nozzle 590. The nozzles 620 are used for controlled atomization of a liquid payload during aerial dispersal and can be retracted when not in use, drastically reducing mechanical stress and power consumption.

The TACT subcomponent servomechanism 640 controls the movement of the sprayer boom extensions 630, adjusting their position based on accessibility for effective application. The thrust-augmented compact-torque (TACT) actuator 610 enhancement by the coreless stator 200 is embodied in the eVTOL's 60 propulsion as well as the vert-pad 490 unit managing sudden environmental changes and operational conditions. The core subcomponent drives power optimization in the numerous aspects of the aerial vehicle's 60 operational envelope, including flight performance, continuous stabilization, and vehicle maneuverability in real-time.

In terms of practical implementation, the ring-wing structure 50 is constructed from short-fiber reinforced composites, carbon/metal fiber composites, and aluminum alloys, selected based on their mass properties, individual anisotropic nature, and tensile strength and durability. The propulsion units 160 consist of synchronized rotor-to-rotor harmonics, load distribution, and nearest-neighbor health monitoring capabilities. The prop blades 180 can be hybrids of tip-to-tip open rotors or toroidal designs. The gyroscopic torque controlled winch and cables of the intelligent pulley and cable system 300 articulate the ring-wing 50 with electrical ratchets, s-hooks, and actuator motors, while the partitioned BAR-QDIS battery 420 units are optimized to improve voltage and power output.

The primary airframe 60 is manufactured using injection molds based on detailed design drawings, ensuring structural strength and stability during flight. The AVIUS GNFCS controller codebase architecture is AI-SOC based and FPGA board modifiable. The design is optimized for efficient power management and control in flight and energy generation. The DDRM-configured thermal, vibrations, and noise monitoring system are equally integrated into the airborne wind energy systems as well as the eVTOLs 60 and vertiport 490, and are all constructed according to custom drawings. The eVTOL's construction uses advanced materials, including short-fiber reinforced composites, shape-memory fabrics 790 (see FIG. 1), and aerospace-grade aluminum alloys, selected for their high tensile strength, light weight, and other characteristics. Specific treatments and coatings, such as thermal wraps, dust, radiation, and anti-corrosive layers, are applied to enhance durability and performance.

The manufacturing process incorporates techniques in additive manufacturing such as 3D printing, injection molding, and complex traditional processes for components and structural elements. These methods allow for precise fabrication of parts, reducing material waste and production time. The drone's 60 modular design also facilitates easier assembly and maintenance, with components designed for quick replacement or upgrade, including RoboHaptiX PACE arms 650 for on-site repairs.

The overall eVTOL 60 product line has undergone mock-up simulations and partial testing in real-world environments. The test trials demonstrated the eVTOL's 60 and control system's versatility, robustness, and functionality under various conditions. The articulated annulus intelligent-wing 50 with distributed propulsion 160 and dynamic gyroscopic stabilization features 330 represent a significant advancement in UAV technology. Its innovative design, modular configurations, and advanced control systems 710 make it a versatile and reliable platform for a wide range of applications, offering enhanced low-level flight stability, safety (anti-crash claims), and operational efficiency in challenging environments.

Without further elaboration, it is believed that one skilled in the art can, using the description herein, utilize the present disclosure to its fullest extent. The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group.

1. An aerial vehicle comprising:
a ring-wing airframe formed of a plurality of articulated ring segments configured to articulate in response to flight dynamics;
a plurality of propulsion units symmetrically integrated into the ring-wing airframe, each propulsion unit comprising a coreless stator motor and a rotor assembly;
a stabilization system comprising:
a plurality of gyro-torque injectors coaxially coupled to the rotor assemblies,
a plurality of servo-actuated tension-brace nodes mounted to the ring-wing airframe, and
a control algorithm configured to inject precessional torque and modulate a center of gravity of the aerial vehicle based on sensor data;
and, a control system comprising a reinforcement learning algorithm and a neural network-based controller configured to dynamically allocate control effort between the propulsion units and the stabilization system in real time.

2. The aerial vehicle of claim 1, wherein each coreless stator motor comprises bimetallic windings formed by additive manufacturing.

3. The aerial vehicle of claim 1, wherein the articulated ring segments are actuated by a multi-axis actuator network coordinated by the control system.

4. The aerial vehicle of claim 1, wherein the reinforcement learning algorithm incorporates fault-state recognition to trigger stabilization compensation.

5. The aerial vehicle of claim 1, wherein the stabilization system is configured to counteract precession and yaw instability during high-torque maneuvers.

6. The aerial vehicle of claim 1, wherein the tension-brace nodes comprise spring-loaded servo joints configured to maintain dynamic rigidity of the ring-wing airframe.

7. An aerial vehicle comprising:
a ring-wing airframe;
a plurality of decentralized battery modules mounted to the ring-wing airframe, each battery module comprising:
a thermo-structural shell,
a battery management micro-regulator,
a sensor suite including a temperature sensor, a pressure sensor, a voltage sensor, and an acoustic sensor, and
an ultra-fast isolation stack comprising a frangible dowel pin, a gallium-nitride switch, and a pyrotechnic fuse configured to sever electrical connection from the aerial vehicle in response to a predicted thermal event;
and, a battery control algorithm comprising a physics-informed neural network trained to anticipate thermal runaway from multi-sensor fusion data and activate the ultra-fast isolation stack.

8. The aerial vehicle of claim 7, wherein the battery modules are galvanically isolated upon triggering of the ultra-fast isolation stack.

9. The aerial vehicle of claim 7, wherein the frangible dowel pin is mechanically actuated by a detonation signal from the battery control algorithm.

10. The aerial vehicle of claim 7, wherein the acoustic sensor detects ultrasonic signatures of phase change events within a battery cell.

11. The aerial vehicle of claim 7, further comprising a power reconfiguration bus for redistributing current among non-isolated battery modules.

12. The aerial vehicle of claim 7, wherein the thermo-structural shell comprises a layered composite configured to contain thermal discharge during isolation.

13. An aerial vehicle comprising:
a ring-wing airframe;
a robotic spray arm mounted beneath the ring-wing airframe, the robotic spray arm comprising a multi-segment boom, a retractable spray nozzle, and a thrust-augmented compact torque actuator;
a para-brella system comprising a shape-memory fabric mounted to the ring-wing airframe and configured to deploy to deflect downwash away from a spray target area;
a dynamic control algorithm configured to synchronize boom actuation, ring-wing articulation, and spray nozzle operation in response to real-time vehicle dynamics; and,
a stabilization system comprising a gyro-torque injector positioned adjacent to the robotic spray arm and configured to counteract torsional disturbances during spraying.

14. The aerial vehicle of claim 13, wherein the robotic spray arm is operated by a neural network-based controller with integrated environmental feedback.

15. The aerial vehicle of claim 13, wherein the para-brella system deploys automatically based on airflow thresholds detected during descent.

16. The aerial vehicle of claim 13, wherein the spray nozzle comprises a cutoff valve actuated in coordination with vehicle velocity and altitude.

17. The aerial vehicle of claim 13, further comprising a compliance monitoring module configured to log vibration data and actuator activity for each spray cycle.

18. The aerial vehicle of claim 13, wherein the dynamic control algorithm is configured to minimize spray drift by adjusting spray rate and boom angle.

19. The aerial vehicle of claim 13, wherein the thrust-augmented torque actuator compensates for inertial lag in the robotic arm movement.

20. The aerial vehicle of claim 13, wherein the gyro-torque injector is mounted coaxially with a counterweight positioned to offset boom extension.
